(19) United States
(12) Patent Application Publication
(10) Pub. No.: US 2017/0314812 A1
(43) Pub. Date: Nov. 2, 2017

(54) AIR FILTER SYSTEM FOR USE WITH INDIVIDUAL ROOM AIR OUTLETS

(71) Applicant: Patrick Joseph Hurley, WOODSTOCK, GA (US)

(72) Inventor: Patrick Joseph Hurley, WOODSTOCK, GA (US)

(21) Appl. No.: 15/143,833

(22) Filed: May 2, 2016

(51) Int. Cl. F24F 13/28; B29C 65/48; F24F 13/08; B01D 46/00; B29L 31/14

(52) U.S. Cl. CPC F24F 13/28; F24F 13/085; B01D 46/0001; B29C 65/48; B29L 2031/14

(57) ABSTRACT

Contaminants present in air ducts or other components of HVAC systems may be carried by moving air passing through the HVAC system and ultimately delivered as air contaminants to rooms in which such contaminated air may be breathed in by humans. An air filter system is described for removing air contaminants from moving air passing through a register or grille between an air duct of a HVAC system and a room. The air filter system includes one or more air filters within an interface housing or secured by a frame that is attached or adhered to the register or grille so that the air filter removes at least some of the air contaminants in the moving air passing from the air duct through the register or grille before it enters the room. Methods for assembling and manufacturing air filter systems are also described.

### FIELD OF THE INVENTION

The present specification relates generally to air filters and more specifically relates to a system for removing air contaminants from moving air at an interface between a duct of a heating, ventilating and air conditioning (HVAC) system and a room.

### BACKGROUND OF THE INVENTION

Today, more than 50 million Americans suffer from allergies and 10-12 million Americans suffer from asthma. It has been suggested that one of six people suffer from allergies because of the fungi and bacteria in the air duct system of their residence and workplace. Moreover, the level of some contaminants in indoor air may be as high as 70 times the level found in outdoor air. It has been put forward that as many as half of all illnesses may be caused or aggravated by contaminants in indoor air. Furthermore, children and the elderly may be particularly susceptible to indoor air quality issues.

Because most people spend about 60 percent to 90 percent of their time indoors, good indoor air quality is important to one's health. Air filters are known and used in establishments to improve indoor air quality by removing air contaminants such as dust, bacteria, pollen, carpet fibers, mold, smoke and pet dander from the air. A furnace filter is a common type of air filter, and is used to remove air contaminants at the interface between an air duct and the furnace so as to reduce or prevent air contaminants from entering into the furnace. However, most commercially available fiberglass filters are less than 7% efficient in removing airborne contaminants from indoor air.

Despite the filtering of airborne contaminants entering a furnace, it is known that, over time, contaminants accumulate inside of the air ducts of a HVAC system as well as other components of a HVAC system. Typically, HVAC components such as furnaces and air conditioners may be serviced by a service technician, who, among other things, cleans out any build-up of contaminants that have accumulated in the furnace or air conditioner since it was last serviced. In the case of air ducts, air duct cleaning services may be available, but for large buildings, such as apartment buildings, such duct cleaning services may be costly and as a result the air ducts may not be cleaned regularly or at all. Moreover, a resident in a building may not be available to authorize air duct cleaning services for the building, and therefore may not be able to bring about the removal of any build-up of contaminants in the building air ducts leading to the rooms in their particular apartment or suite. Without regular air duct cleaning and furnace and air conditioner maintenance, individuals with respiratory health conditions, environmental allergies or sensitivities to allergens may find the indoor air quality to be problematic for them.

Registers or grilles are typically used at the interface between air ducts and a room in a building. A register has moving components that allow a user to restrict air flow through the openings in a register, while a grille has the same openings to allow air flow there though as a register without the moving parts that allow a user to restrict the air flowing from them. Registers or grilles are not designed to accommodate air filters and at this time only rudimentary cut-to-fit polyester filter sheets are sold for air vents without an accompanying securing mechanism.

Accordingly, there remains a need for improvements in the art.

### SUMMARY OF THE INVENTION

In accordance with an aspect of the invention, there is provided an air filter system for securing to an interface between an air conduit in a HVAC system and a room, the system for removing at least some air contaminants from moving air passing through the interface between the air conduit in the HVAC system and the room so as to improve the indoor air quality in the room.

According to an embodiment of the invention, the present invention provides an air filter system for securing to an interface between an air conduit in a HVAC system and a room, the system for removing at least some air contaminants from moving air passing through the interface between the air conduit in the HVAC system and the room, the system comprising: at least one air filter; and a securing mechanism for attaching the air filter to the interface such that the at least one air filter removes at least some air contaminants from the moving air before the moving air enters the room.

According to a further embodiment, the present invention provides a method for assembling an air filter system for securing to an interface between an air conduit in a HVAC system and a room, the system for removing at least some air contaminants from moving air passing through the interface between the air conduit in the HVAC system and the room, the method comprising: removing one or more release sheets covering adhesive on two or more flaps of a frame securing at least one air filter; and adhering the flaps to the interface between the air conduit and the room so as to place the at least one air filter between moving air from the air conduit and the room so as to allow the at least one air filter to remove at least some air contaminants from the moving air before it enters the room.

According to a further embodiment, the present invention provides a method of manufacturing an air filter system for securing to an interface between an air conduit in a HVAC system and a room, the system for removing at least some air contaminants from moving air passing through the interface between the air conduit in the HVAC system and the room, the method comprising: folding and cutting a cardboard sheet into a frame for securing at least one air filter, the frame including a right side panel, a left side panel, a rear side panel, a front side panel and at least two sealing flaps; adhering the frame to the at least one air filter so as to secure the at least one air filter to the frame; applying an adhesive to the at least two sealing flaps, the adhesive being sufficiently strong so as to allow the frame to be secured to a register or grille; and covering the adhesive with one or more removable release sheets.

According to a further embodiment, the present invention provides an air filter system for securing between an air conduit in a HVAC system and a room, the system for removing at least some air contaminants from moving air passing through the interface between the air conduit in the HVAC system and the room, the system comprising: a frame capable of being secured around an opening between the air conduit in the HVAC system and the room; an interface at least partially releasably secured to the frame; and at least one air filter for positioning between the interface and the air conduit.

According to a further embodiment, the present invention provides an air filter housing for positioning at least one air filter between an air conduit in a HVAC system and a room, the housing comprising: a frame capable of being secured around an opening between the air conduit in the HVAC system and the room; and an interface at least partially releasably secured to the frame; wherein at least one air filter may be positioned between the interface and the air conduit.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a perspective view of an air filter system according to an embodiment as secured to a register between a duct of a HVAC system and a room;

FIG. 2 is an exploded view of an air filter system, register and air duct according to an embodiment;

FIG. 3 is an exploded view of a register and air filter system according to an embodiment;

FIG. 4A is a front view of an air filter according to an embodiment, FIG. 4B is a side view of the air filter of FIG. 4A, and FIG. 4C is a top view of the air filter of FIG. 4A;

FIG. 5 is a view of an unassembled cardboard frame for securing around one or more air filters according to an embodiment;

FIG. 6 is a perspective view of a second embodiment of an air filter system which is secured to a ceiling of a room and is shown in an open position for inserting or replacing an air filter; and

FIG. 7 is a cross-sectional side view of the air filter system of FIG. 6 after the air filter has been loaded.

Like reference numerals indicate like or corresponding elements in the drawings.

### DETAILED DESCRIPTION OF THE EMBODIMENTS

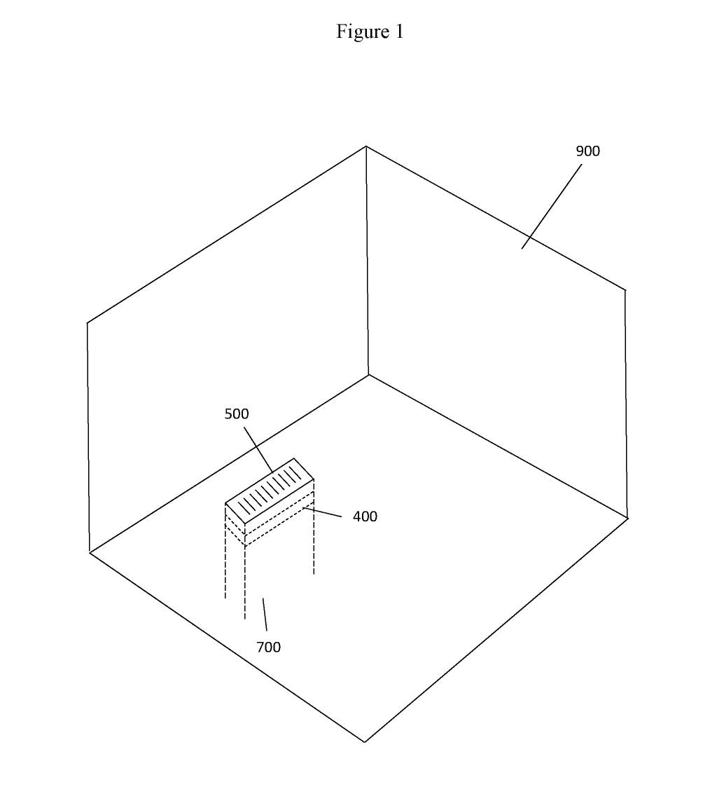

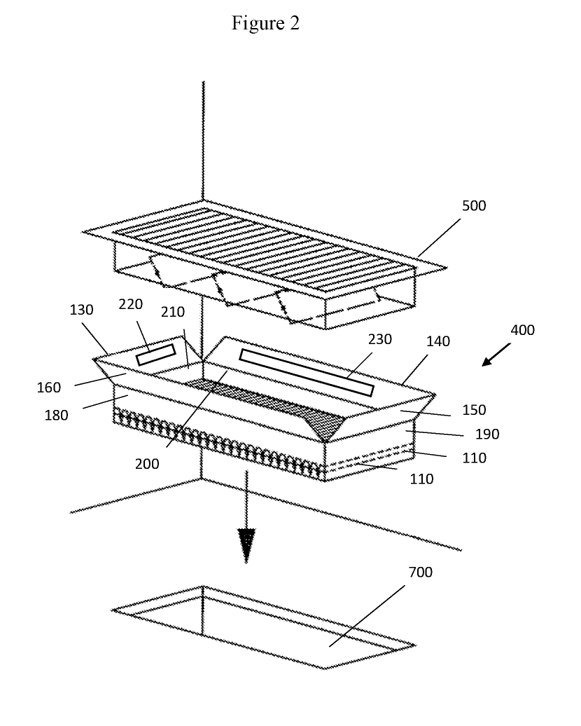

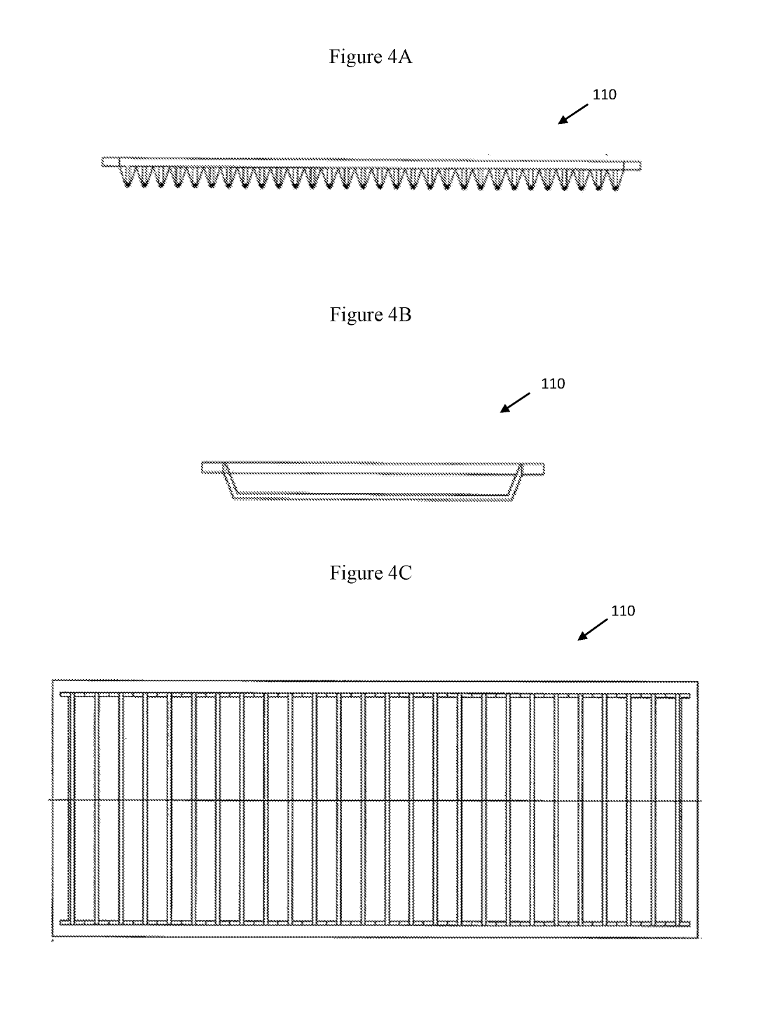

According to embodiments as shown in FIGS. 1, 2, 3, 4A, 4B, 4C, and 5, an air filter system 400 may be secured to an interface, such as a register 500 or grille, in a floor, ceiling or wall of a room 900. Such interfaces are already existing in buildings and are generally found positioned between an air conduit, such as air duct 700, in a HVAC system (not shown) operating in the building and the particular room 900. The air filter system 400 may include at least one air filter 110 which may remove at least some air contaminants from the moving air passing through the interface, such as register 500, between the air conduit, such as air duct 700, in the HVAC system and the room 900. According to an embodiment, the air filter system 400 may comprise at least two air filters 110. Since a dirty air filter may cause greater reduction of air flow through the air filter 110 than a clean or new air filter, the air filter 110 should be cleaned, if possible, or replaced at regular intervals to limit any reduction in air flow into the room 900 that may be caused by the presence of air filter 110.

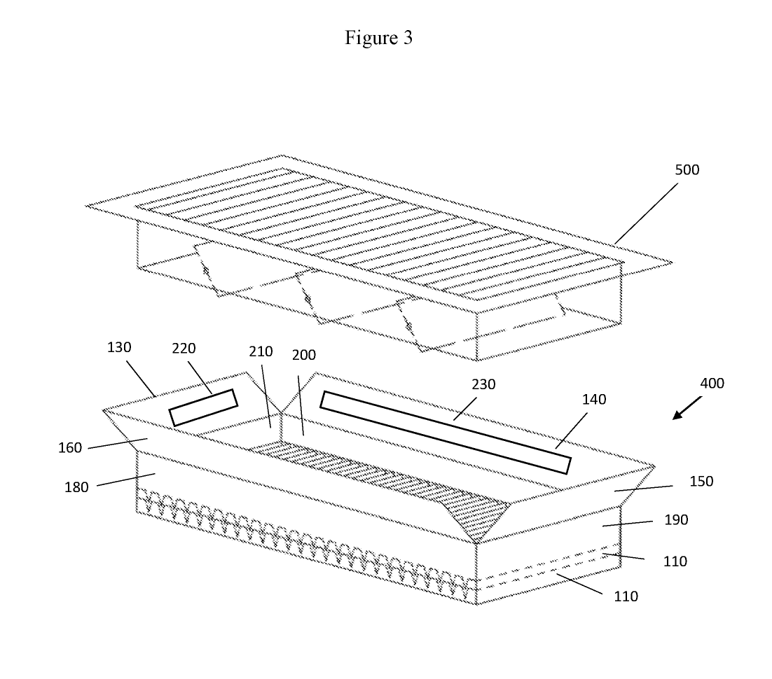

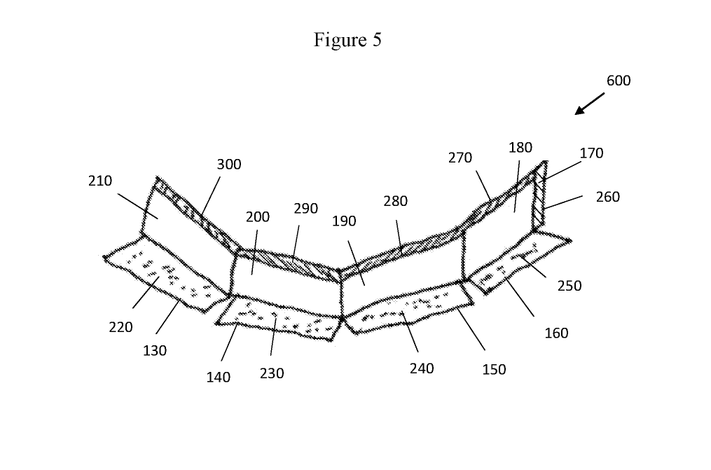

According to embodiments as shown in FIGS. 3 and 5, the air filter system 400 may comprise a frame 600, which may be made of cardboard or any other suitable material for securing to an air filter. The frame 600 may comprise a sealing tab 170, a right side flap 140, a left side flap 160, a rear side flap 150, a front side flap 130, a right side panel 200, a left side panel 180, a rear side panel 190 and a front side panel 210.

According to embodiments as shown in FIGS. 3 and 5, an inner surface of the sealing tab 170, the right side flap 140, the left side flap 160, the rear side flap 150 and the front side flap 130 may comprise an adhesive placed thereon as shown by sealing tab adhesive 260, a right side flap adhesive 230, a left side flap adhesive 250, a rear side flap adhesive 240 and a front side flap adhesive 220, respectively. The adhesives on the flaps may be covered by removable release sheets that may prevent the adhesives from adhering to anything other than the release sheet prior to the release sheet being removed when the air filter system 400 is ready to be installed. Then, for use, the air filter system 400 may be assembled by the purchaser by removing the one or more release sheets covering the adhesive and adhering the flaps to the interface, such as register 500.

According to an embodiment as shown in FIG. 5, the sealing tab 170 may be an extension of the left side panel 180. The sealing tab 170 may be positioned onto an outer surface of the front side panel 210 and adhered by the sealing tab adhesive 260 so as to create an assembled frame 600. The at least one air filter 110 may be placed inside the frame 600 after it is assembled or alternatively the frame 600 may be assembled around the perimeter of the at least one air filter 110. The frame 600 may be adhered to the at least one air filter through the use of glue or another adhesive, or by any other suitable means for securing the at least one air filter 110 to the frame 600. According to an embodiment, a lower portion of an inner surface of the right side panel 200, the left side panel 180, the rear side panel 190 and the front side panel 210 may comprise a right side panel adhesive 290, a left side panel adhesive 270, a rear side panel adhesive 280 and a front side panel adhesive 300, respectively.

According to an embodiment, the air filter system 400 may be attached to a bottom or rear surface of an interface such as register 500 by positioning two or more flaps with adhesive thereon onto the bottom or rear surface of the interface. According to a further embodiment, the air filter system may be attached to the top or front of the interface such as register 500 or a grille. While attaching the air filter system 400 to the bottom or rear surface will generally obscure it from view and therefore be more aesthetically appealing, attaching the air filter system to the front of the register or grille may be functionally equivalent and may be more suitable where the grille is not removable or at least not easily removed by the occupant of the room.

According to a further embodiment, the frame 600 may be secured to the interface, such as register 500, using one or more clips, which may be made from plastic or metal or another suitable material. The clips would attach to the interface either through two attaching openings in the register or grille or around perimeter edges of the grille or register 500. According to an embodiment, at least two clips may be used to ensure secure engagement of the frame 600 with the interface. Such a clip may be made integral with the frame or separate and attachable by the user.

According to an embodiment, the air filter system may be manufactured by first folding and cutting a cardboard sheet into frame 600. Then the frame 600 may be adhered to the at least one air filter 110 such as with the use of glue or another suitable adhesive or attached by another securing mechanism. Further, an adhesive may be applied to two or more of the flaps and then covered with one or more removable release sheets. According to an embodiment, the adhesive may be sufficiently strong so as to allow the frame 600 to be secured to a register 500 or grille.

According to a further embodiment, at least one air filter 110 may be mounted or received inside a housing of an interface, for example, a specially-configured register or grille. Such a specially configured register may be made of plastic or metal or any other suitable material for the particular indoor use.

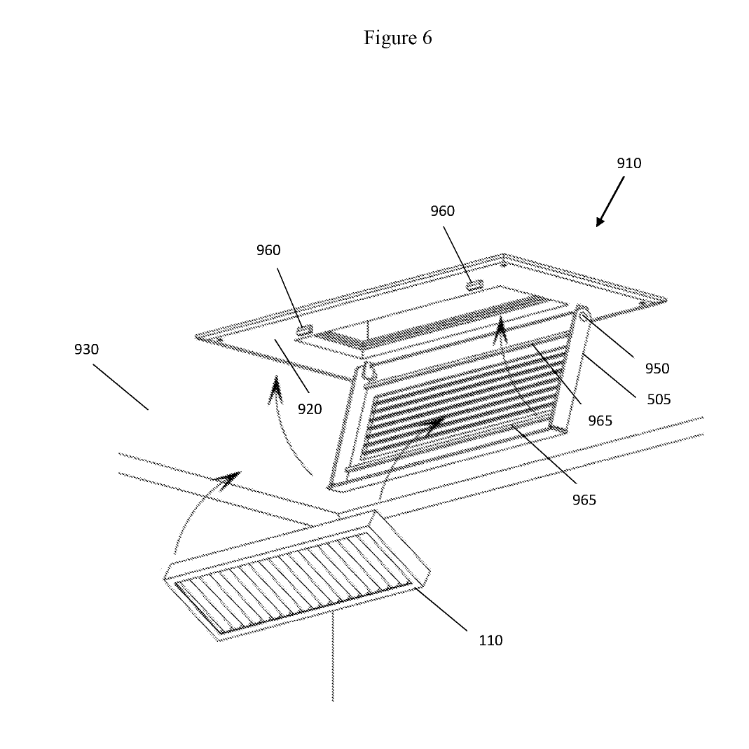

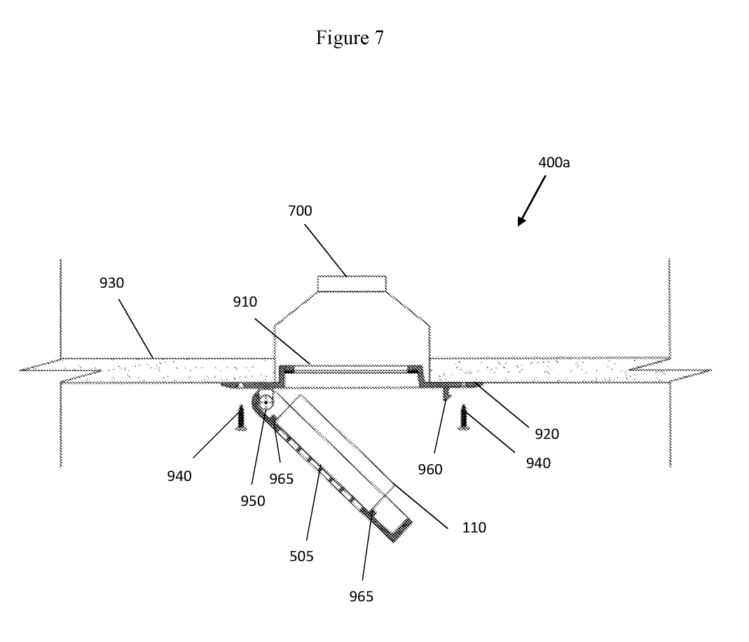

According to an embodiment as shown in FIGS. 6 and 7, an air filter system 400a may comprise an interface housing 910 which may comprise an interface, such as a register or grille 505, which may connect at a pivot 950 to a frame 920 that may be secured to a ceiling 930, wall or floor, and inside which interface housing 910 at least one air filter 110 may be housed or positioned so that the at least one air filter 110 is situated between the interface and the air conduit. The air filter system 400a may be used in place of, or to replace, a standard interface in a building.

According to an embodiment, a gasket 910 may optionally be used with air filter system 400a. Optional gasket 910 may be made from material that acts as a seal and allows for compression, such as foam, and may be seated on the side of the frame 920 that is adjacent to the air conduit and shaped so as not to impede air flow between the air conduit and the at least one air filter 110.

According to an embodiment, the frame 920 may be configured so as to be capable of being placed generally flush with a flat surface such as a ceiling 930, wall or floor, and secured to the surface using two or more screws 940 or other suitable securing mechanisms.

According to an embodiment as shown in FIGS. 6 and 7, the frame 920 may also include one or more releasable clips 960. The clips 960 may be unclipped to allow the interface to pivot about pivot 950 and permit the at least one air filter 110 to be inserted or replaced within the interface housing 910. According to an embodiment, the interface housing 910 may be configured to receive the at least one air filter 110 and allow it to be mounted or at least partially secured or impeded from movement such as through ridges 965 on the register or grille 505 which are sized so that they may impede the at least one air filter 110 from shifting movement while the air filter system 400a is in use filtering moving air. Once the at least one air filter 110 has been replaced or inserted, the register or grille 505 may be pivoted closed and then held in place by securing the clips 960. Further, other mechanisms for partially or fully releasably securing the interface may be employed so long as they allow the at least one air filter 110 to be inserted or replaced as needed.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. An air filter system for securing to an interface between an air conduit in a HVAC system and a room, the system for removing at least some air contaminants from moving air passing through the interface between the air conduit in the HVAC system and the room, the system comprising:
at least one air filter; and
a securing mechanism for attaching the air filter to the interface such that the at least one air filter removes at least some air contaminants from the moving air before the moving air enters the room.

2. The air filter system of claim 1, wherein the interface is a register or a grille.

3. The air filter system of claim 1, wherein the securing mechanism is an adhesive for adhering the at least one air filter to the interface.

4. The air filter system of claim 3, wherein the at least one air filter is secured by a frame.

5. The air filter system of claim 4, wherein the frame includes two or more flaps to which the adhesive has been applied.

6. The air filter system of claim 5, further comprising one or more removable release sheets covering the adhesive.

7. The air filter system of claim 3, wherein the frame comprises cardboard.

8. The air filter system of claim 1, wherein the at least one air filter comprises at least two air filters.

9. The air filter system of claim 1, wherein the securing mechanism comprises a clip for securing the at least one air filter to the interface.

10. The air filter system of claim 1, wherein the securing mechanism for attaching the air filter to the interface is integral to the interface.

11. A method for assembling an air filter system for securing to an interface between an air conduit in a HVAC system and a room, the system for removing at least some air contaminants from moving air passing through the interface between the air conduit in the HVAC system and the room, the method comprising:
removing one or more release sheets covering adhesive on two or more flaps of a frame securing at least one air filter; and
adhering the flaps to the interface between the air conduit and the room so as to place the at least one air filter between moving air from the air conduit and the room so as to allow the at least one air filter to remove at least some air contaminants from the moving air before it enters the room.

12. The method of claim 11, wherein the interface is a register or grille.

13. The method of claim 11, wherein the at least one air filter comprises at least two air filters.

14. A method of manufacturing an air filter system for securing to an interface between an air conduit in a HVAC system and a room, the system for removing at least some air contaminants from moving air passing through the interface between the air conduit in the HVAC system and the room, the method comprising:
folding and cutting a cardboard sheet into a frame for securing at least one air filter, the frame including a right side panel, a left side panel, a rear side panel, a front side panel and at least two flaps;
adhering the frame to the at least one air filter so as to secure the at least one air filter to the frame;
applying an adhesive to the at least two flaps, the adhesive being sufficiently strong so as to allow the frame to be secured to a register or grille; and
covering the adhesive with one or more removable release sheets.

15. The method of claim 14, further comprising folding the sealing flaps over the top of the at least one air filter such that the air filter system presents a generally rectangular shape.

16. An air filter system for securing between an air conduit in a HVAC system and a room, the system for removing at least some air contaminants from moving air passing through the interface between the air conduit in the HVAC system and the room, the system comprising:
a frame capable of being secured around an opening between the air conduit in the HVAC system and the room;
an interface at least partially releasably secured to the frame; and
at least one air filter for positioning between the interface and the air conduit.

17. The air filter system of claim 16, wherein the interface is a register or a grille.

18. The air filter system of claim 17, wherein the register or grille comprises plastic or metal.

19. The air filter system of claim 16, further comprising a gasket seated on the frame between the frame and the air conduit.

20. The air filter system of claim 19, wherein the gasket comprises foam.

21. The air filter system of claim 16, wherein the frame is secured around the opening using at least two screws.

22. The air filter system of claim 16, wherein the interface is partially releasably secured to the frame by at least one pivot connecting the frame and the interface and at least one releasable clip such that unclipping the at least one releasable clip allows the interface to be pivoted about the pivot.

23. The air filter system of claim 16, wherein the interface comprises at least one ridge for impeding the at least one air filter from shifting movement.

24. An air filter housing for positioning at least one air filter between an air conduit in a HVAC system and a room, the housing comprising:
a frame capable of being secured around an opening between the air conduit in the HVAC system and the room; and
an interface at least partially releasably secured to the frame;
wherein at least one air filter may be positioned between the interface and the air conduit.

25. The air filter housing of claim 24, wherein the interface is a register or a grille.

26. The air filter housing of claim 25, wherein the register or grille comprises plastic or metal.

27. The air filter housing of claim 24, wherein the frame is secured around the opening using at least two screws.

28. The air filter housing of claim 27, wherein the interface is partially releasably secured to the frame by at least one pivot connecting the frame and the interface and at least one releasable clip such that unclipping the at least one releasable clip allows the interface to be pivoted about the pivot.

29. The air filter housing of claim 24, wherein the interface comprises at least one ridge.
